(19) United States
(12) Patent Application Publication
(10) Pub. No.: US 2008/0124695 A1
(43) Pub. Date: May 29, 2008

(54) Non-intrusive audio book

(76) Inventor: Cary Michael Myers, Spring Valley, CA (US)

Correspondence Address: Mr. Cary Michael Myers, 725 Ramona Avenue, Spring Valley, CA, 91977, US

(21) Appl. No.: 11/586,951

(22) Filed: Oct. 26, 2006

(51) Int. Cl. G09B 5/00

(52) U.S. Cl. 434/317

(57) ABSTRACT

An audio device concealed within a traditional book wherein said device is non-intrusive on the traditional reading experience and is compatible with the habits of the avid reader, functional for the professional author, and useful for the enhancement of the literary art form.

### REFERENCES

United States Patent Documents

| | | |
|---|---|---|
| 4425098 | January 1984 | Doring |
| 4809246 | February 1989 | Jeng |
| 4884974 | December 1989 | DeSmet |
| 4990092 | February 1991 | Cummings |
| 5209665 | May 1993 | Billings |
| 5290190 | March 1994 | McClanahan |
| 5419705 | May 1995 | Sandvik |
| 5533757 | June 1996 | Morris |
| 5531600 | July 1996 | Baer |
| 5538430 | July 1996 | Smith |
| 5567163 | October 1996 | Ku |
| 5569868 | October 1996 | Leung |
| 5769642 | June 1998 | Shinohara |
| 5847698 | December 1998 | Reavey |
| 6064855 | May 2000 | Ho |
| 6167233 | December 2000 | Gresser, Jr. |
| 6229502 | May 2001 | Schwab |
| 6313828 | November 2001 | Chombo |
| 6405167 | June 2002 | Cogliano |
| 6421524 | July 2002 | Padgett |
| 6525706 | February 2003 | Rehkepmer |
| 6792243 | September 2004 | Ka-wah |
| 6933928 | August 2005 | Lilienthal |
| 6985693 | January 2006 | Kirwan |
| 7010261 | March 2006 | Kim |
| 7035583 | April 2006 | Ferrigno |

### BACKGROUND OF THE INVENTION

1. Field of the Invention

The present invention relates generally to books capable of producing sound to enhance the reading experience, and more particularly to traditional books (those written on paper pages bound within a hard cover) which incorporate audio devices that are functional for both the professional author and the avid reader.

2. Description of the Prior Art

Over the years there have been a number of books that incorporate audio devices. Many focus on education and are used primarily for enhancing the learning experience of children. In addition to sound, visual stimulants such as toys, pop-ups, and animations are often incorporated into the book (for example U.S. Pat. No. 7,035,583). Some audio books function as note takers, and are used for the recording and playback of messages spoken by the reader (for example U.S. Pat. No. 6,167,233). Several include video screens (for example U.S. Pat. No. 6,525,706), and some are paperless, focusing strictly on multimedia (for example U.S. Pat. Nos. 6,933,928, and 6,229,502). Others need to be connected to secondary devices in order to function properly (for example U.S. Pat. Nos. 7,010,261, 6,064,855, and 4,884,974).

On some audio books the audio is triggered by the turning of a page (for example U.S. Pat. No. 4,809,246), and on others it is triggered by pressing a button (for example U.S. Pat. Nos. 5,531,600, 5,209,665, and 4,990,092). Both of these methods are faced with the same problem: the audio is likely to be heard before the corresponding point in the text is reached, like accidentally reading the end of the book first, the reader may unintentionally interact with the audio device prior to the appropriate location in the text, thus taking the sound out of context, and dampening the reading experience.

Collectively, audio books of the Prior Art are not useful for professional authors, and not functionally compatible with the habits of avid readers. In general, the literary person—and in particular, the professional fiction author—has little use for gadgetry in relaying his or her art form to the public. He or she has little use for devices that take the focus away from the words themselves. The written word is best displayed on the written page, free from intrusion, allowing the reader to become absorbed in the text. In order for an audio book to be functional for the avid reader, and useful to the professional author, it must fit within the habits and customs of the traditional reading experience.

### BRIEF SUMMARY OF THE INVENTION

The present invention is an audio book device wherein the audio components are undetectably and permanently incorporated into the spine, cover, and tassels of the book. The components that are visible remain undetectable as audio components in that they do not reveal that the book contains an audio device. A reader that has never held such a book will not know he or she is holding a book capable of producing audio until he or she reaches the appropriate point in the text. Upon reaching the proper point in the text the reader will be confronted with an asterisk that refers to a footnote, which gives instructions on how to use the device. An explanative footnote is only needed on the initial audio prompt, as the reader will know how to activate the device when confronted with all further prompts.

The audio is activated by the reader's interaction with a numerical key column which is affixed to the inside, of the back cover, and is level with the surface of the cover. The numerical key column is capable of receiving a three-digit code, which corresponds to a page number. To remain undetectable as a component of an audio device this key column can be disguised as artwork, or a publisher's mark.

The audio is heard through tassels incorporated into the book that are capable of receiving audio output, producing sound, and functioning as earpieces. Upon seeing the initial audio prompt (asterisk or other symbol chosen by author) the reader is referred to a footnote which instructs him or her to turn to the back of the book, enter the page number into the numerical key column, and place one or both of the tassel ends in or near his or her ear to hear the music.

The audio device of the present invention is compatible with the traditional reading experience in that it utilizes prompts in the text to refer to footnotes and appendices. It provokes actions that are compatible with the traditional reading experience, and conceals audio components within the customary parts of a traditional book. Furthermore, the present invention functions without the need for external secondary devices.

Just as the reader of a traditional book has the choice not to read the written appendices, the reader of the Non-intrusive Audio Book has the choice not to listen to the audio appendices. This method is functional for the professional author in that it allows him or her to enhance a literary work by adding audio in much the same way he or she would add a footnote or an appendix. Therefore, the Non-intrusive Audio Book provides a new medium, which transcends the art of the traditional literary experience while remaining faithful to its form and style. The Non-intrusive Audio Book is useful because it is consistent with the habits established by the traditional format.

The primary objective of the present invention is to construct an audio device within a traditional book wherein said audio device is non-intrusive on the traditional reading experience.

Another objective of the present invention is to construct an audio device within a traditional book wherein said audio device is undetectable.

Another objective of the present invention is to construct an audio book device that is useful to the professional fiction author.

Another objective of the present invention is to construct an audio book device that is functional for the avid reader.

### BRIEF DISCRIPTION OF DRAWINGS

FIG. 1 is an outside front view of the audio book device of the present invention in the closed position, illustrating a construction in the manner of a traditional book.

FIG. 2 is an outside rear view of the audio book device in the closed position, further illustrating a construction in the manner of a traditional book.

FIG. 3 is an inside front view of the audio book with the front cover in the open position, further illustrating a construction in the manner of a traditional book.

FIG. 4 is an inside view of the audio book in the open position with two written pages exposed, illustrating an example of the initial prompt in the text to notify the reader how to activate the device.

FIG. 5 is an inside rear view of the audio book with the rear cover in the open position,.illustrating the numerical key column and the camouflage thereof as artwork around a publisher's mark.

FIG. 6 is a block diagram view of the concealed audio components within the spine, cover, and tassels of the audio book.

### DETAILED DESCRIPTION OF THE INVENTION

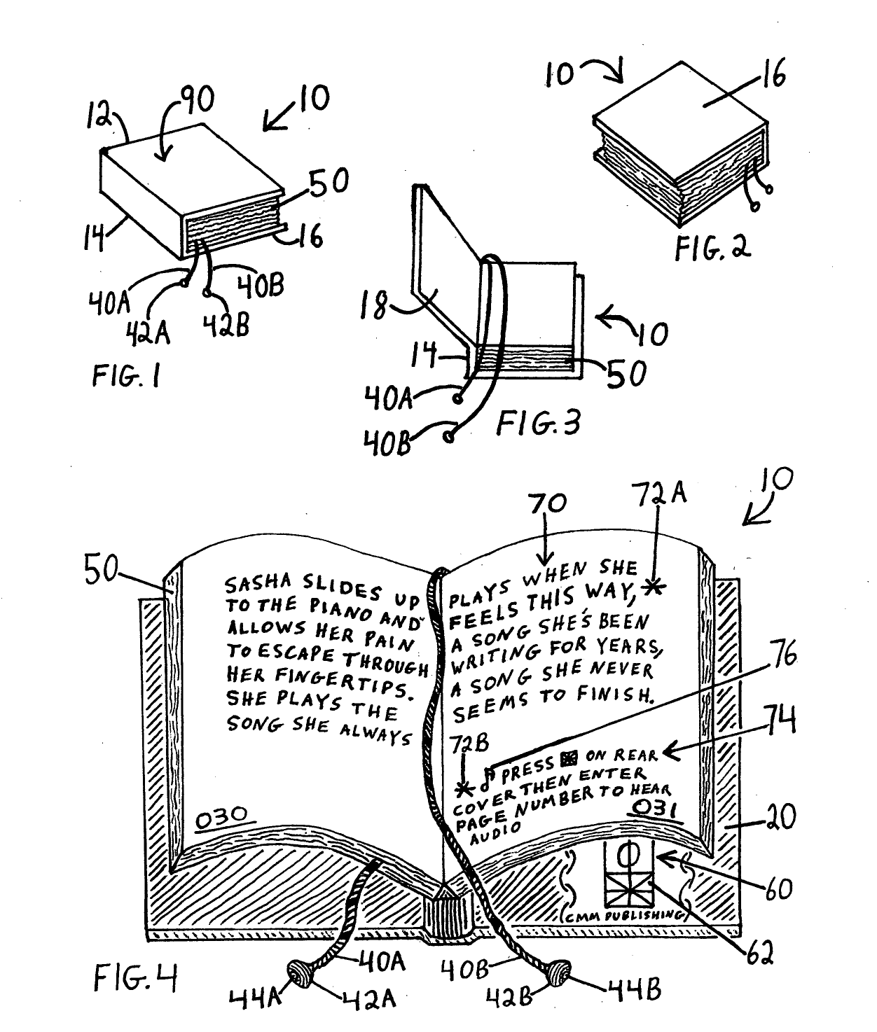

The drawings displayed in FIG. 1 through FIG. 6 illustrate the embodiment of the present invention. Referring to FIG. 1, audio book 10 of the current invention is displayed from a frontal view in the closed position. The audio book 10 is composed of a hard cover 90, which is constructed from a front cover 12 and a rear cover 16, which are joined together by a spine 14. Connected to the interior of the spine 14 between the front cover 12 and the rear cover 16 are a plurality of paper pages 50. Cover 90 is considered a hard cover in that it is constructed of material that is considerably thicker and more rigid than the paper pages 50. Cover 90 is constructed in thickness and form in a manner that retains the essence of a traditional book. Dangling down from the pages 50 are two tassels 40A and 40B, which are made of rope or ribbon. Wooden tassel ends 42A and 42B are connected to the ends of said tassels. FIG. 1 illustrates that the audio book 10 of the present invention retains the form of a traditional book: namely, a book square or rectangular in shape, which incorporates words written on paper pages bound within a hard cover.

FIG. 2 is a rear view of audio book 10 in the closed position with rear cover 16 exposed, further illustrating that audio book 10 retains the essence of a traditional book.

FIG. 3 is a frontal view of audio book 10 in the open position with the inside front cover 18 exposed, further illustrating that audio book 10 retains the essence of a traditional book. Tassels 40A and 40B are shown draped across the top of pages 50. Tassels 40A and 40B originate from within the top of spine 14 and are of a length that extends past the bottom of paper pages 50. The audio book 10 is constructed so that upon inspection of the front, the back, and the inside front cover with tassels exposed, as illustrated by FIG. 1, FIG. 2, and FIG. 3, a first time reader would not know the book contains an audio device. It is the purpose of the current invention to surprise the first time reader with the element of audio, and to provide repeat readers with an audio element that is non-intrusive on the traditional reading experience: in a word, to make the audio device undetectable.

FIG. 4 is a view of audio book 10 in the open position with page 030 and page 031 exposed. Tassel 40A is sandwiched between the plurality of pages 50 and tassel 40B is dangling atop page 030 and page 031. Tassel ends 42A and 42B have small holes 44A and 44B incorporated into them. Tassels 40A and 40B conceal cables 140A and 140B that connect to miniature speakers 142A and 142B that are hidden within tassel ends 42A and 42B (further illustrated in FIG. 6). Referring to FIG. 4, tassel ends 42A and 42B function as acoustical chambers that allow sound to escape through holes 44A and 44B. Tassel ends 42A and 42B are made of wood or plastic and are of a size that can comfortably rest within the ear or just outside of it. Thus, tassels 40A and 40B are capable of receiving audio output from audio components concealed within the spine 14, and are capable of producing sound and functioning as earpieces.

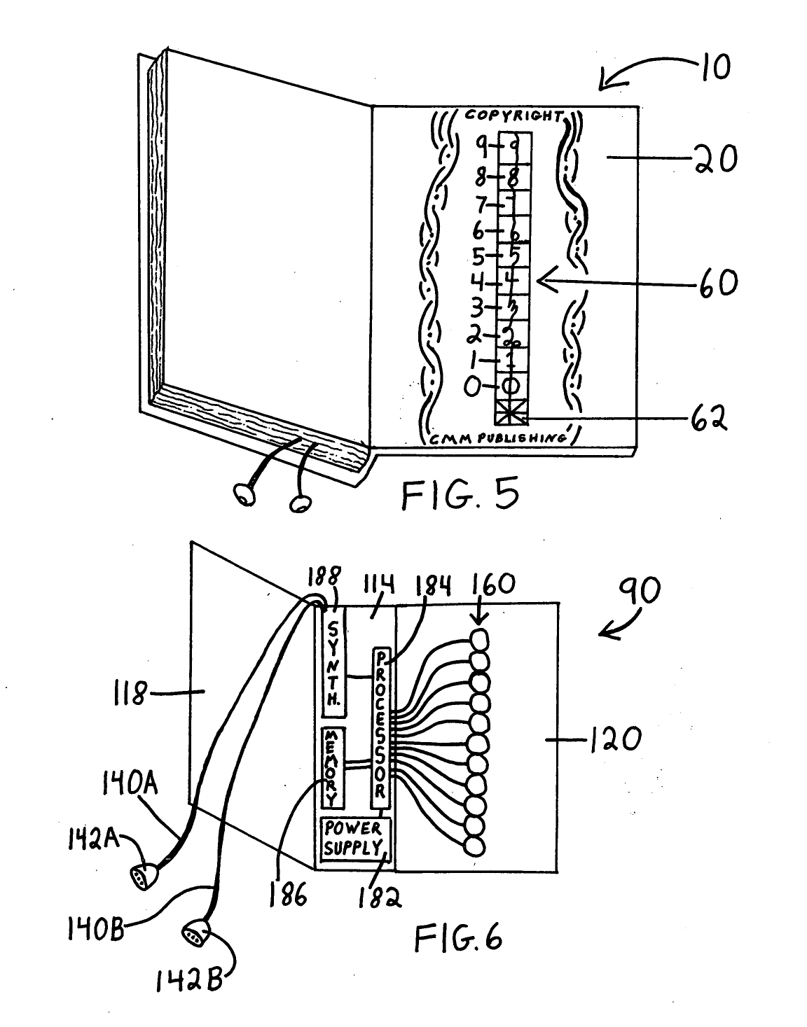

Referring to FIG. 4, when the reader reaches the asterisk 72A in the text 70 on page 031, he or she will be directed to footnote 74. Asterisk 72A is an example of the initial prompt that guides the reader to the initial footnote 74 which notifies the reader that an audio device is present. In the initial footnote 74 the asterisk 72B is followed by a musical symbol 76, which is then followed by an explanation of how the reader uses the audio portion of the audio book 10. In all following prompts an asterisk can lead to a footnote that simply displays the musical symbol 76, and thus refers the reader to the audio without the use of written words, and therefore an explanation or lengthy footnote is only needed on the initial audio prompt. In footnote 74 the reader is instructed to press input key 62 on the inside rear cover 20, and then enter the page number. The page number is entered into the numerical key column 60 on the inside rear cover 20 using input keys 62 and 0, 1, 2, 3, 4, 5, 6, 7, 8, and 9—as illustrated in FIG. 5. Input key 62 is used to clear the device of any prior entries and to prepare the device for the input of a three-digit page number using input keys 0, 1, 2, 3, 4, 5, 6, 7, 8, and 9.

The wording of footnote 74 in FIG. 4 is short due to space restrictions. It is to be understood that the author could choose a symbol other than asterisk 72A, and could use wording other than footnote 74. On an actual book the footnote could be longer and more explanative. The wording of the footnote is the author's choice. The author could leave the footnote short, and allow the reader to discover where to type the page number and how to listen to the audio; or the author could explain the device in detail. In summary, the device is operated by the reader placing one or both of the tassel ends 42A and 42B in or near his or her ear, and then turning to the rear inside cover 20 and then pressing input key 62 followed by the three-digit page number of the corresponding audio prompt in the text.

It is clear that the reader must reach the appropriate point in the text to find the page number to input into the numerical key column and hear the corresponding audio. In other words, the audio can't be heard until the corresponding page number is found. Therefore, the audio is heard only in context—thus becoming useful for creating deeper meaning within the written word.

The construction of audio book 10, and the method of its use, creates a new medium for the professional author by seamlessly adding the option of audio to the writing experience. It is clear from the text 70 in FIG. 4 that a key objective of the present invention is to allow music to be incorporated into traditional prose. Many professional authors are also songwriters, and clearly audio book 10 is of great use to them, but even authors that are not musicians benefit from the use of audio book 10 by employing musicians to bring new life to their writing. In traditional books landscapes and personalities can be described, pictures and paintings can be drawn, but the nuances of music are difficult to convey with words alone, and are often outside the realm of expression for the literary artist. The implementation of musical scores properly assimilated into the traditional reading experience elevates the art of literature to new, and undiscovered heights. For example, in a book with a musician as the lead character, this new medium is indispensable in the development of that character.

FIG. 5 is a rear view of audio book 10 in the open position with the inside rear cover 20 exposed, illustrating the numerical key column 60 and the camouflage thereof as artwork around a publisher's mark. The purpose of this construction is not to completely hide the numbers of the numerical key column 60, but to display them in a manner that makes them undetectable as input keys for an audio device. Therefore, the numerical key column 60 is level with the surface of the inside rear cover 20, and the input keys 0 through 9 and 62 do not feel like buttons to the touch, but only depress slightly, with a textural feel similar to the surface of the inside rear cover 20 as a whole. Due to lack of space the numerical key column 60 appears large in FIG. 5. On an actual book the numerical key column 60 could be smaller in comparison to the rear inside cover 20, and could be camouflaged in different ways, according to the author's preference.

The numerical key column 60 is the only part of the audio book 10 which may bring the undetectability of the audio components into question. It is important that the numerical key column 60 is constructed in a manner wherein its true character is hidden, and that it is undetectable as a component of an audio device. The Roget's International Thesaurus Fifth Edition lists several words as synonymous with undetectable, for example: hidden, unobserved, unnoticed, disguised, camouflaged, concealed, and behind the curtain or scenes. Something that is undetectable is something that has its true character hidden wherein said character is not capable of being discovered without obtaining further information. It must be kept in mind that the author could leave out the initial footnote 74, and the numerical display on rear cover 20, and include no clues in the text referring to the audio, if he or she wanted the audio portion of audio book 10 to remain undiscovered. The audio device is undetectably incorporated into the audio book 10 in that it cannot be detected without the proper information being supplied by the author. Therefore, even though numerical key column 60 is exposed, it remains undetectable as a component of an audio device and is constructed in a manner that does not reveal its true character. The numerical key column 60 is constructed in a manner that does not reveal that an audio device is present within the audio book 10, thus the entire audio device and all of its components are undetectably concealed within the cover 90 and the tassels 40A and 40B as illustrated in FIG. 1 through FIG. 6.

FIG. 6 is an internal view of hard cover 90 wherein the internal front cover 118 is connected to the internal rear cover 120 by the internal spine 114. A block diagram view of the concealed audio components is shown within the hard cover 90. The internal views of the tassels are also shown wherein the wires 140A and 140B connect to miniature speakers 142A and 142B. Affixed on the inside rear cover 120 is the column of sensors 160. The sensors 160 are positioned directly under numerical key column 60 and are capable of receiving a four-digit code (corresponding to the depression of input key 62 followed by a three-digit page number). Processor 184 processes the four-digit code and the corresponding audio is retrieved from digital memory component 186. The digital audio is then coupled to synthesizer 188 through processor 184 and audio output is sent through wires 140A and 140B to produce sound through miniature speakers 142A and 142B. A battery, as illustrated by power supply 182, powers the audio components.

1. A book constructed in traditional form comprised of words written on paper pages bound within a hard cover, wherein said book contains a concealed audio device wherein the components of said audio device are undetectably and permanently incorporated into the spine, cover, and tassels of the book.

2. The book of claim 1 further comprising a numerical key column permanently affixed on the inside of the rear cover and utilized for activating audio by receiving the input of a page number.

3. The book of claim 1 further comprising tassels capable of receiving audio output and functioning as earpieces.
